(19) United States
(12) Patent Application Publication
(10) Pub. No.: US 2004/0158552 A1
(43) Pub. Date: Aug. 12, 2004

(54) System and method for visually mining information

(76) Inventors: Chung-I Lee, Tu-Chen (TW); Chien-Fa Yeh, Tu-Chen (TW); Yang He, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/749,311

(22) Filed: Dec. 31, 2003

(30) Foreign Application Priority Data
Dec. 31, 2002 (TW) 91137952

(51) Int. Cl. G06F 17/30

(52) U.S. Cl. 707/2

(57) ABSTRACT

A system for visually mining information includes a data mining module (121) and a dynamic scanning module (122). The data mining module is for mining data from a structured information report, and comprises: a parameter obtaining sub-module (1211); and a querying sub-module (1213). The dynamic scanning module comprises a scanning sub-module (1221); an identifying sub-module (1223); and a marking sub-module (1224). A related method includes the steps of: obtaining downloading parameters and a scanning command; generating a query sentence in accordance with the obtained parameters; querying a local database server (15); displaying a structured information report and a scanning image, wherein the scanning image includes a scanning needle; scanning each field of the structured information report; identifying whether a scanned field contains data matching the query sentence; and marking the field if the field contains data matching the query sentence.

### BACKGROUND OF THE INVENTION

1. Field of the Invention

The present invention relates to a computer data processing system in an information system, and especially to a system and method for visually mining information from a structured report.

2. Background of the Invention

Patents are becoming more and more important to a manufacturing business's success, especially in today's globalized economy. Patents comprise information on technologies, laws, economics, and other strategic information. Nowadays, numerous government patent offices have patent databases open to public. Such offices include the United States Patent and Trademark Office (USPTO), the European Patent Office (EPO), the State Intellectual Property Office of the People's Republic of China (CPO), and the Japanese Patent Office (JPO). These patent databases are freely accessible through their respective web sites on the Internet. However, few corporations conduct significant patent searching and analysis. One important reason for this is the difficulty in identifying relevant patents, and the difficulty in analyzing patents. Any major patent database contains an overwhelming number of patents, only a fraction of which are useful to a particular corporation. It is generally difficult for a corporation to efficiently search for useful patents. Even if the corporation finds useful patents, conducting patent analysis manually is a very difficult, tedious and time-consuming task.

There are some software tools for patent analysis currently available, such as SmartPatent Workbench from SmartPatents Inc. U.S. Pat. No. 5,991,751 entitled “System, Method, and Computer Program Product for Patent-Centric and Group-Oriented Data Processing” provides the patent analysis tool of SmartPatent Workbench. The invention provides tools for patent-centric and group-oriented data processing. The invention is primarily designed to assist a user in analyzing patents by integration with non-patent information such as corporate operational data, financial information, production information, human resources information and other types of corporate information. A typical patent information report merely comprises analysis data on a group of patents having a common feature or characteristic. For example, the analysis data may be statistics on inventors, patentees, patent application dates, patent issue dates, or patent classifications. Yet SmartPatent Workbench typically has to analyze the above statistics in several respective operations, not in a single operation. U.S. Pat. No. 6,339,767, owned by Aurigin System, Corp., is related to data processing tools that use hyperbolic trees to visualize data generated by patent-centric and group-oriented processing. This provides enhanced patent citation analysis and claim analysis beyond that provided by U.S. Pat. No. 5,991,751. Nevertheless, none of the above-described technologies do not provides tools or functions for satisfactory detailed analysis.

### SUMMARY OF THE INVENTION

Accordingly, an objective of the present invention is to provide a system and method for visually mining information which helps to analyze data.

Another objective of the present invention is to provide a system and method for visually mining information which can generate structured information reports in accordance with user defined variables and various data on a project.

In order to achieve the above-mentioned objectives, a system for visually mining information in accordance with the present invention comprises a data mining module and a dynamic scanning module. The data mining module is for mining data from a structured information report, and comprises: a parameter obtaining sub-module for obtaining mining parameters and a scanning command; and a querying sub-module for querying data from the information report in accordance with the mining parameters. The dynamic scanning module comprises a scanning sub-module for scanning the information report; an identifying sub-module for identifying whether data stored in a field of the structured information report match the mining parameters; and a marking sub-module for marking a identified field of the information report with a designated mark.

Further, in order to achieve the above-mentioned objectives, a method for visually mining information in accordance with the present invention comprises the steps of: (a) obtaining downloading parameters and a scanning command; (b) generating a query sentence in accordance with the obtained parameters; (c) querying a local database server; (d) displaying a structured information report and a scanning image, wherein the scanning image comprises a scanning needle; (e) scanning fields of the structured information report; (f) identifying whether a scanned field contains data matching the query sentence; and (g) marking the field if the field contains data matching the query sentence.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware configuration of a system for visually mining information in accordance with a preferred embodiment of the present invention, the system comprising a plurality of client computers, an application server, a local database server and a remote database server;

FIG. 2 is a block diagram of function modules of the application server, one of the client computers, the local database server and the remote database server of FIG. 1;

FIG. 3 is a schematic diagram of function sub-modules of an auto-count module of the application server;

FIG. 4 is a schematic diagram of function sub-modules of a data mining module of the application server;

FIG. 5 is a schematic diagram of function sub-modules of a dynamic scanning module of the application server;

FIG. 6 illustrates an exemplary structured information report generated in accordance with the present invention;

FIG. 7 illustrates exemplary scanning of the structured information report of FIG. 6;

FIG. 8 is a flow chart of a preferred method for generating a structured information report in accordance with the present invention;

FIG. 9 is flow chart of a preferred method for mining data from patents in accordance with the present invention; and

FIG. 10 is a flow chart of a preferred method for displaying detailed mined information in accordance with the present invention.

### DETAILED DESCRIPTION OF PREFERRED

### EMBODIMENTS OF THE INVENTION

Reference will now be made to the drawings to describe the present invention in detail.

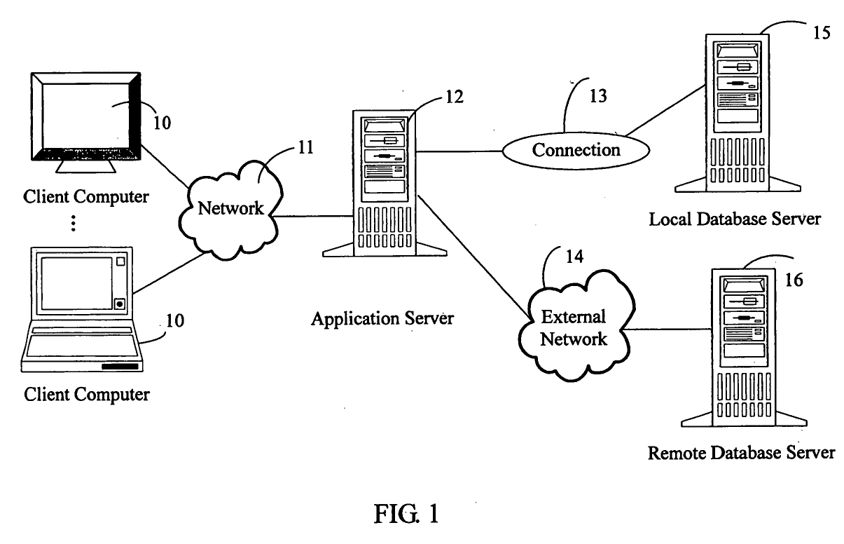

FIG. 1 is a schematic diagram of hardware configuration of a system for visually mining information in accordance with the preferred embodiment of the present invention. The system for visually mining information comprises a three-layer information system. The three-layer information system comprises a data access layer, a business logic layer, and a presentation layer. The data access layer comprises a local database server 15. The business logic layer comprises an application server 12. The presentation layer comprises a plurality of client computers 10, each located in a respective workshop. A network 11 interconnects the business logic layer and the presentation layer. The network 11 can be the Internet, an intranet, or another suitable kind of electronic communication network. A connection 13 interconnects the business logic layer and the data access layer. The connection 13 can be an open database connectivity (ODBC), or a Java database connectivity (JDBC).

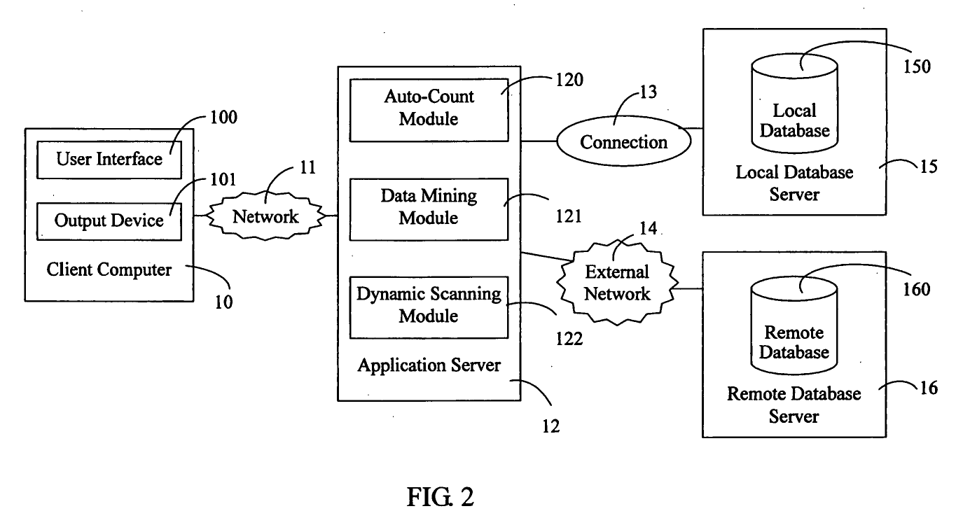

The local database server 15 has a database located therein, which stores all structured data of an enterprise that employs the system for visually mining information. The local database server 15 is used for managing processing of the stored data. Such processing includes reading, writing, deleting, modifying, and backup. The application server 12 comprises core and mutable enterprise logic (such as rules, execution, and management) of the system for visually mining information. The application server 12 comprises a plurality of software modules (described in detail below in relation to FIG. 2). The application server 12 processes input of users, and returns results of processing to the users. Via the client computers 10, users can access the application server 12 and read structured information reports.

The application server 12 is also connected with a remote database server 16 via an external network 14. The external network 14 is an electronic communication network such as the Internet.

FIG. 2 is a block diagram of function modules of the application server 12, one of the client computers 10, the local database server 15, and the remote database server 16. The client computer 10 comprises a user interface 100 and an output device 101. The user interface 100 is an interactive interface. Users input processing commands to the system for visually mining information via the user interface 100. The output device 101 displays results of processing to the users.

The remote database server 16 comprises a remote database 160. The remote database 160 comprises various data required by users. For example, if the users want to analyze patent data, the remote database 160 may be a patent database. Popular patent databases include the database of the United States Patent and Trademark Office, the database of the European Patent Office, the database of the State Intellectual Property Office of P.R. China, and the patent family database of LexisNexis Corporation. The local database server 15 comprises a local database 150. The local database 150 stores data downloaded from the remote database 160. Such data may, for example, be patent data or patent family data.

The application server 12 comprises an auto-count module 120, a data mining module 121, and a dynamic scanning module 122. The auto-count module 120 obtains data from a designated database, and generates a structured information report in accordance with a user command. The data mining module 121 mines analysis data from the structured information report in accordance with the user's command. The dynamic scanning module 122 is used to scan the structured information report, and displays the analysis data that the data mining module 121 mines from the structured information report.

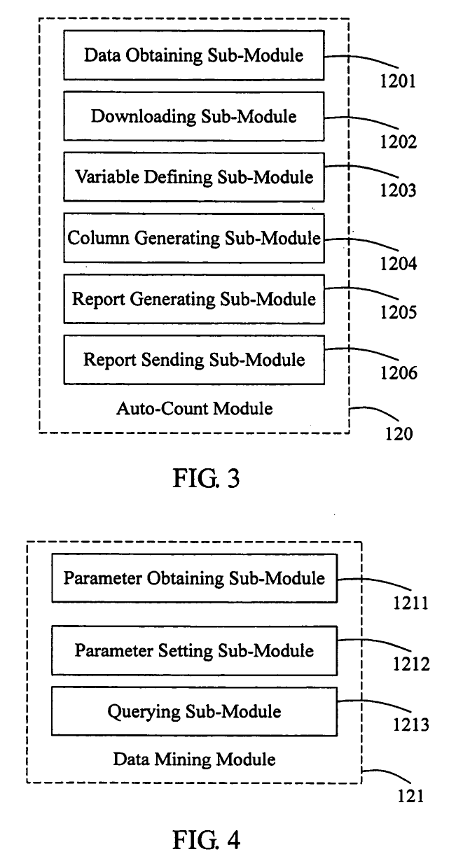

FIG. 3 is a schematic diagram of function sub-modules of the auto-count module 120 of the application server 12. The auto-count module 120 comprises a data obtaining sub-module 1201, a downloading sub-module 1202, a variable defining sub-module 1203, a column generating sub-module 1204, a report generating sub-module 1205, and a report sending sub-module 1206.

The data obtaining sub-module 1201 obtains data input by users via the client computers 10, the data comprising parameters for downloading. The downloading sub-module 1202 is used to download data in accordance with parameters that the users input from the client computers 10. The variable defining sub-module 1203 defines variables of structured information reports in accordance with users' commands. For example, if patent data are downloaded and a patent information report is required, two different variables of structured information reports are defined: “year” and “classification.” The column generating sub-module 1204 is for generating columns and/or rows of a structured information report in accordance with the variables defined by the variable defining sub-module 1203 and data downloaded by the downloading sub-module 1202. For example, if a structured information report having the variable “year” is desired, and data on times downloaded by the downloading sub-module 1202 include years in the range from 1986 to 2001, the column generating sub-module 1204 generates sixteen year columns (or rows) accordingly. In another example, if a structured information report having the variable “classification” is desired, and data downloaded by the downloading sub-module 1202 include classifications A and B, the column generating sub-module 1204 generates two classification columns (or rows) accordingly The report generating sub-module 1205 is used for generating a new structured information report in accordance with data downloaded by the downloading sub-module 1202 and columns/rows generated by the column generating sub-module 1204. The structured information report is stored in the local database server 15. The report sending sub-module 1206 sends the structured information report to a designated user for reference and analysis.

FIG. 4 is a schematic diagram of function sub-modules of the data mining module 121 of the application server 12. The data mining module 121 comprises a parameter obtaining sub-module 12 11, a parameter setting sub-module 1212, and a querying sub-module 1213. The parameter obtaining sub-module 1211 obtains parameters for mining detailed data and commands for scanning from users. The parameter setting sub-module 1212 is used to generate an SQL sentence in accordance with parameters obtained by the parameter obtaining sub-module 1211. The querying sub-module 1213 is for searching for useful data in the structured information report in accordance with the SQL sentence.

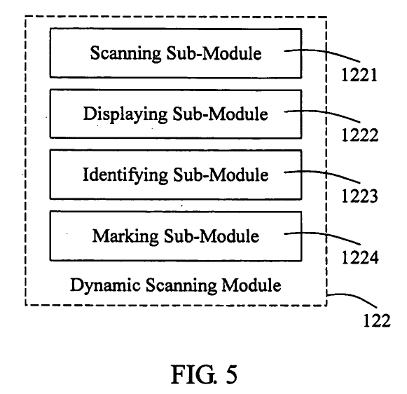

FIG. 5 is a schematic diagram of function sub-modules of the dynamic scanning module 122 of the application server 12. The dynamic scanning module 122 comprises a scanning sub-module 1221, a displaying sub-module 1222, an identifying sub-module 1223, and a marking sub-module 1224.

The scanning sub-module 1221 is used to scan the structured information report generated by the report generating sub-module 1205. The displaying sub-module 1222 is for displaying the structured information report on a relevant client computer 10, together with scanning images produced by the scanning sub-module 1221. The identifying sub-module 1223 is provided for identifying whether any data contained in the structured information report match the SQL sentence generated by the querying sub-module 1213. The marking sub-module 1224 marks any data matching the SQL sentence with a designated color in the structured information report.

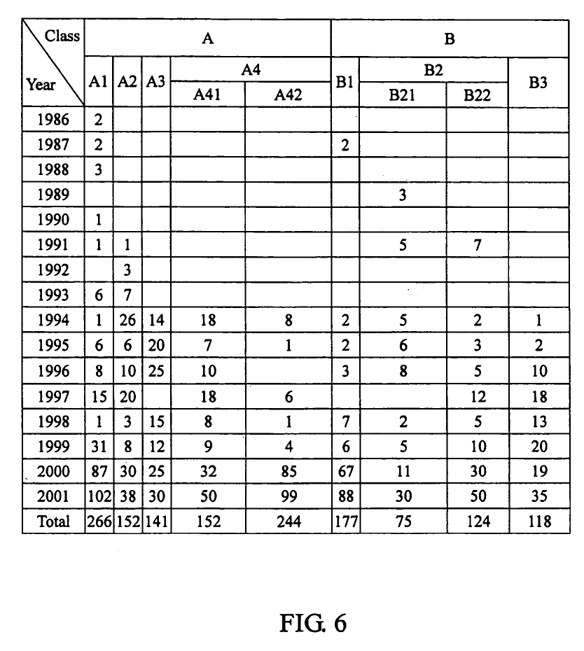

FIG. 6 illustrates an exemplary structured information report generated in accordance with the present invention. The structured information report comprises both a year variable and a classification (“class”) variable. The year variable ranges from 1986 to 2001, and is divided into sixteen rows accordingly. The classification variable comprises classification A and classification B. Classification A comprises sub-classifications A1, A2, A3, and A4; and sub-classification A4 comprises sub-classifications A41 and A42. Classification B comprises sub-classifications B1, B2, and B3; and sub-classification B2 comprises sub-classifications B21 and B22. Thus the classification variable is divided into nine columns accordingly. Numbers in the fields of a main body of the structured information report show quantities of records for corresponding years and corresponding classifications. For example, five records in year 1994 belong to sub-classification B21. In the preferred embodiment of the present invention, a user can read a record list by clicking on a corresponding number using a computer mouse.

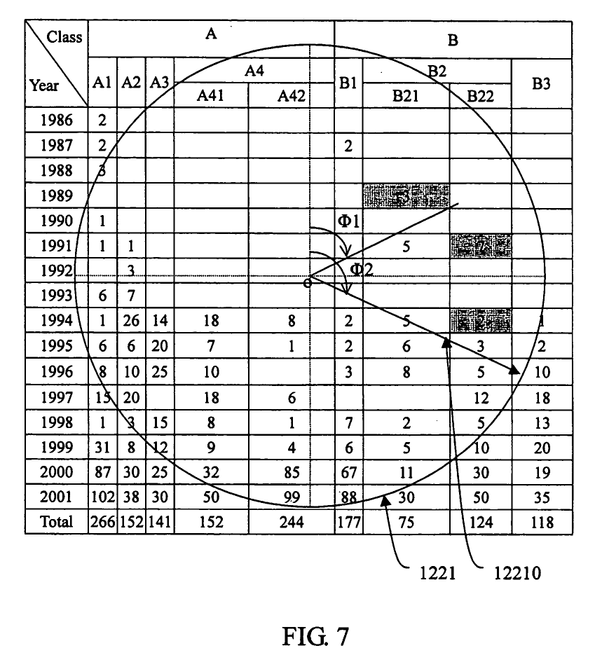

FIG. 7 illustrates exemplary scanning of the structured information report of FIG. 6, in accordance with the present invention. In the preferred embodiment of the present invention, a radarscope system is used, and the scanning sub-module 1221 generates a rotating scanning needle 12210. The scanning needle 12210 is centered on a center of the structured information report, and can start scanning at any position on the structured information report. In the preferred embodiment of the present invention, the scanning needle 12210 starts at the twelve o'clock position and rotates clockwise. A line from the center of the structured information report to a last corner of any field of the structured information report defines an angle Φ1 with respect to the starting position of the scanning needle 12210. A degree of rotation of the scanning needle 12210 from the starting position defines an angle Φ2. The identifying sub-module 1223 identifies whether each field comprises records matching the SQL sentence while the scanning needle 12210 scans the field. If a field comprises records matching the SQL sentence, the marking sub-module 1224 marks the field with the designated color as the scanning needle 12210 sweeps over the field.

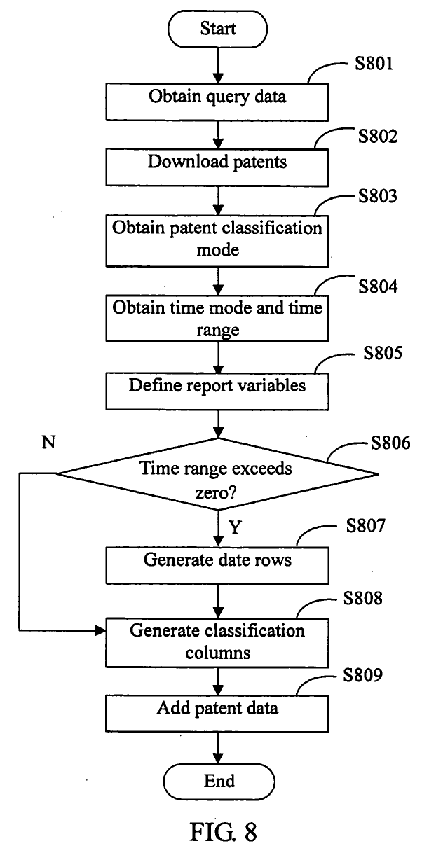

FIG. 8 is a flow chart of a preferred method for generating a structured information report, in accordance with the present invention. In the preferred method, a patent information report is generated. Firstly, in step S801, the data obtaining sub-module 1201 obtains query data input by a user via one of the client computers 10. The query data are for downloading patents, and comprise inventors, patentees, or other key words. In step S802, the downloading sub-module 1202 downloads patents from the remote database server 16 in accordance with the input query data, and stores the downloaded patents in the local database server 15. In step S803, the data obtaining sub-module 1201 obtains a patent classification mode input by the user. The classification mode may be the international patent classification, the United States of America patent classification, or a user defined patent classification.

In step S804, the data obtaining sub-module 1201 obtains a time mode and a time range input by the user. The time mode may be time of application, time of publication, or time of issue of patents. The time range may use years or months as units. For example, a time range can be 1986-2001 if year units are used, and the time range can be 1986.1-2001.12 if month units are used. In step S805, the variable defining sub-module 1203 defines variables of the patent information report. In the preferred method, the variables of the patent information report comprise the patent classification and the patent application time, and the patent application time uses years as units.

In step S806, the column generating sub-module 1204 identifies whether the time range input by the user exceeds zero. If the time range does not exceed zero, the procedure goes directly to step S808 described below. If the time range exceeds zero, in step S807, the column generating sub-module 1204 generates date rows of the patent information report in accordance with the time range and the time units. In step S808, the column generating sub-module 1204 generates classification columns of the patent information report in accordance with the classification mode input by the user. The classification columns show the detailed classification data. For example, if a classification A is divided into sub-classifications A1, A2, A3, and A4, and the sub-classification A4 is divided into sub-classifications A41 and A42, then five classification columns A1, A2, A3, A41, and A42 are generated. In step S809, the report generating sub-module 1205 adds the patent data downloaded by the downloading sub-module 1202 into the patent information report, thereby completing the patent information report. The completed patent information report can be sent to a designated user by the report sending sub-module 1206 for reference and analysis.

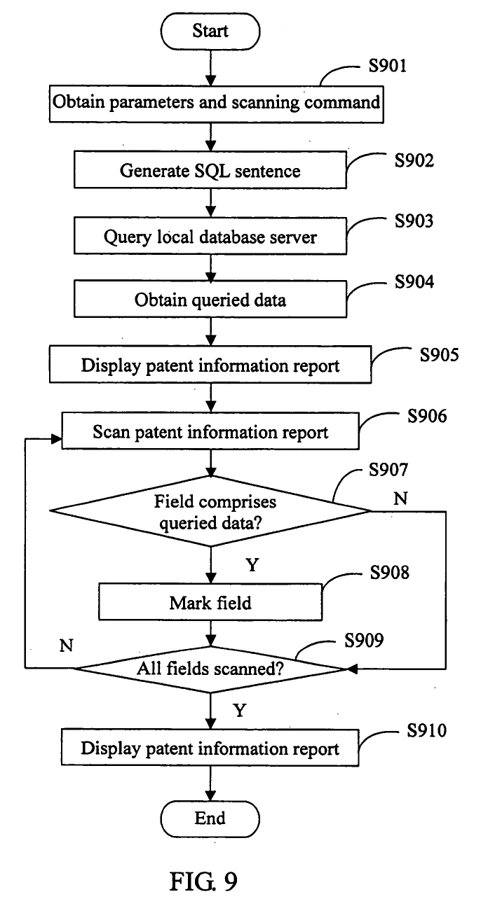

FIG. 9 is flow chart of a preferred method for mining data from patents, in accordance with the present invention. The method is based on the patent information report generated by the auto-count module 120. In step S901, the parameter obtaining module 1211 obtains parameters of a query and a scanning command. The scanning command makes the scanning sub-module 1221 starting scanning the patent information report. In step S902, the parameter setting sub-module 1212 generates an SQL sentence for querying patent analysis data in accordance with the query parameters obtained by the parameter obtaining sub-module 1211. In step S903, the querying sub-module 1213 queries data stored in the patent information report in the local database server 15. In step S904, the querying sub-module 1213 obtains the queried data.

In step S905, the displaying sub-module 1222 displays the patent information report on the relevant client computer 10, together with scanning images generated by the scanning sub-module 1221. The scanning images are overlaid on the patent information report, so that the scanning images and the patent information report are displayed in a single integrated view (as shown in FIG. 7). In step S906, the scanning sub-module 1221 scans the patent information report. As the scanning needle 12210 sweeps over each field of the patent information report, in step S907, the identifying sub-module 1223 identifies whether the field swept over comprises data that the querying sub-module 1213 obtained. If the field does not comprise said data, the procedure goes directly to step S909 described below. If the field comprises said data, in step S908, the marking sub-module 1224 marks the field with a designated color as soon as the scanning needle 12210 has swept over the field. In step S909, the identifying sub-module 1223 determines whether all the fields have been scanned by the scanning sub-module 1221. If any field has not been scanned, the procedure returns to S906. If and when all the fields have been scanned, in step S910, the displaying sub-module 1222 displays the scanned patent information report with the scanning images removed. The marked fields on the patent information report are easily viewed by a user.

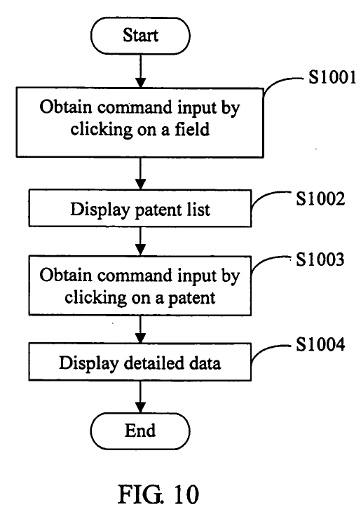

FIG. 10 is a flow chart of a preferred method for displaying detailed mined information, in accordance with the present invention. In step S1001, the parameter obtaining sub-module 1211 obtains a command input by the clicking on a marked field of the patent information report. In step S1002, the displaying sub-module 1222 displays a patent list comprised in the marked field. In the preferred method, patents in the patent list are arranged in order of patent number, with the patents matching the SQL sentence. In step S1003, the parameter obtaining sub-module 1211 obtains a command input by the clicking on a particular patent in the patent list. In step S1004, the displaying sub-module 1222 displays detailed data on the patent selected, such as a full text of the patent.

Although only a preferred embodiment and preferred methods of the present invention have been described in detail above, those skilled in the art will readily appreciate that many modifications to the preferred embodiment and methods are possible without materially departing from the novel teachings and advantages of the present invention. Accordingly, all such modifications are deemed to be covered by the following claims and allowable equivalents of the claims.

What is claimed is:

1. A system for visually mining information, the system being programmed to mine data from a structured information report for analyzing, being deployed on a three-layer information system, and comprising:
a data mining module for mining data from the structured information report, the data mining module comprising:
a parameter obtaining sub-module for obtaining mining parameters and a scanning command; and
a querying sub-module for querying data from the structured information report in accordance with the mining parameters; and
a dynamic scanning module comprising:
a scanning sub-module for scanning the structured information report;
an identifying sub-module for identifying whether data stored in a field of the structured information report match the mining parameters; and
a marking sub-module for marking an identified field of the structured information report with a designated mark.

2. The system as claimed in claim 1, wherein the data mining module further comprises a parameter setting sub-module for generating an SQL (Structured Query Language) sentence in accordance with the mining parameters.

3. The system as claimed in claim 3, wherein scanning sub-module generates a scanning needle for scanning each of the fields of the structured information report.

4. A method for visually mining information, the method comprising the steps of:
obtaining downloading parameters and a scanning command;
generating a query sentence in accordance with the obtained parameters;
querying a local database server;
displaying a structured information report and a scanning image, wherein
the scanning image comprises a scanning needle;
scanning fields of the structured information report;
identifying whether a scanned field contains data matching the query sentence; and
marking the field if the field contains data matching the query sentence.

5. The method as claimed in claim 4, wherein the generated query sentence is an SQL (Structured Query Language) sentence.

6. The method as claimed in claim 4, wherein when the structured information report and the scanning image are displayed, the scanning image is overlaid on the structured information report such that the structured information report and the scanning image are displayed in a single integrated view.

7. The method as claimed in claim 4, further comprising the step of:
determining whether all the fields of the structured information report have been scanned;

8. The method as claimed in claim 4, further comprising the step of:
obtaining a command input by a mouse click, and displaying a data list.
